(19) United States
(12) Patent Application Publication
(10) Pub. No.: US 2010/0106761 A1
(43) Pub. Date: Apr. 29, 2010

(54) Method, Apparatus, and Computer Program Product for Identifying Techniques for Solving Functions

(75) Inventors: Claudio Brunelli, Tampere (FI); Heikki Berg, Viiala (FI); David Guevorkian, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/260,456

(22) Filed: Oct. 29, 2008

(51) Int. Cl. G06F 17/11

(52) U.S. Cl. 708/446

(57) ABSTRACT

An apparatus for identifying techniques for solving functions may include a processor. The processor may be configured to identify a function and identify candidate techniques for solving the function. The processor may also be configured to separate a domain of the function into a plurality of domain intervals and determine respective cost indicators for each candidate technique as applied to each domain interval of the function. Further, the processor may be configured to select a technique for each domain interval based on the cost indicators; and provide for configuring an application processor to solve the function via the selected techniques and the respective domain intervals. Associated methods and computer program products may also be provided.

### TECHNICAL FIELD

Embodiments of the present invention relate generally to computational analysis, and, more particularly, relate to a method, apparatus, and a computer program product for identifying a process for calculating mathematical functions.

### BACKGROUND

The employment of computing devices, such as processors, e.g., microprocessors, to calculate solutions to mathematical functions has sometimes been problematic due to their digital nature. Computing devices are typically capable of solving many mathematical functions, or at least approximating a solution, but the process of reaching the solution can sometimes be computationally intensive for the computing device and therefore costly, in terms of numbers of computations, time, and power consumption.

Since the computer age has introduced computing devices to substantially all aspect of our lives, the use of computing devices to solve mathematical functions, particularly computationally complex mathematical functions, is becoming increasingly common. For example, computing devices are frequently employed in the fields of applied mathematics, computational science, electronics, and telecommunications to calculate solutions to mathematical functions and apply the results. In these fields, it is often necessary to calculate several different kinds of mathematical functions, ranging from the elementary ones, to trigonometric and transcendental functions.

Particularly for telecommunications and electronics applications, techniques currently exist that are aimed at calculating functions within a certain accuracy using approximations. Examples of these include techniques such as the Coordination Rotation Digital Computer (CORDIC) method, Briggs' method for logarithms, Newton's method, Taylor series expansion, Spline interpolation, linear interpolation, Padé rational approximation, and the Chebychev approximation. These techniques provide means for computing devices to calculate many functions in terms of elementary operations such as multiplications, additions, and divisions. However, use of these techniques does not guarantee that the solutions for the mathematic functions fall within a desired precision margin. Further, use of a conventional technique may not result in a minimum cost for the computing device to determine the solution.

### BRIEF SUMMARY

A method, apparatus, and computer program product are described that identify techniques for solving functions, such as mathematical functions. In this regard, embodiments of the present invention determine a cost indicator that describes the cost associated with solving a function using a candidate technique (e.g., CORDIC method, Briggs' method for logarithms, Newton's method, Taylor series expansion, Spline interpolation, linear interpolation, Padé rational approximation, Chebychev approximation, or the like). The cost indicator may indicate the efficiency of using the candidate technique to solve the function. Efficiency may be determined with respect to the number of computations, time, power usage, memory usage, or the like needed to determine a solution to the function. In some embodiments, a cost indicator may describe the cost with respect to a specific domain interval of the function. In this regard, the domain of the function may be separated into domain intervals and cost indicators may be determined for each candidate technique with respect to each domain interval. Also, in some exemplary embodiments, the candidate techniques may be eliminated if the maximum error of the technique for the value of variables in the domain interval exceeds a threshold error. Further, candidate techniques may be selected based on the cost indicators. For example, the candidate techniques may be selected that have a minimum cost value as indicated by the cost indicators. The selected techniques may be used to configure an application processor. In this regard, the application processor may be configured to solve the function using the selected techniques when deployed in the field or used by consumers.

Accordingly, in one exemplary embodiment, a method for identifying techniques for solving functions is described. The method may include identifying a function and identifying candidate techniques for solving the function. The method may also include separating a domain of the function into a plurality of domain intervals and determining respective cost indicators for each candidate technique as applied to each domain interval of the function. Further, the method may also include selecting a technique for each domain interval based on the cost indicators; and providing for configuring an application processor to solve the function via the selected technique for each respective domain interval.

In another exemplary embodiment, an apparatus for identifying techniques for solving functions is described. The apparatus may include a processor. The processor may be configured to identify a function and identify candidate techniques for solving the function. The processor may also be configured to separate a domain of the function into a plurality of domain intervals and determine respective cost indicators for each candidate technique as applied to each domain interval of the function. Further, the processor may be configured to select a technique for each domain interval based on the cost indicators; and provide for configuring an application processor to solve the function via the selected technique for each respective domain interval.

In another exemplary embodiment, a computer program product for identifying techniques for solving functions is described. The computer program product may include at least one computer-readable storage medium having computer-readable program code instructions stored therein. The computer-readable program code instructions may be configured to identify a function and identify candidate techniques for solving the function. The computer-readable program code instructions may also be configured to separate a domain of the function into a plurality of domain intervals and determine respective cost indicators for each candidate technique as applied to each domain interval of the function. Further, the computer-readable program code instructions may be configured to select a technique for each domain interval based on the cost indicators; and provide for configuring an application processor to solve the function via the selected technique for each respective domain interval.

In yet another exemplary embodiment, an apparatus for identifying techniques for solving functions is described. The apparatus may include means for identifying a function and means for identifying candidate techniques for solving the function. The apparatus may also include means for separating a domain of the function into a plurality of domain intervals and means for determining respective cost indicators for each candidate technique as applied to each domain interval of the function. Further, the apparatus may also include means for selecting a technique for each domain interval based on the cost indicators; and means for providing for configuring an application processor to solve the function via the selected technique for each respective domain intervals.

Various other methods, apparatuses, and computer program products are also provided for identifying techniques for solving functions. For example, another apparatus may include a processor, and the processor may be configured to solve a function with an input, wherein the function is solved via a selected technique associated with a domain interval indicated by the input. The selected technique may have been selected by identifying candidate techniques, separating a domain of the function into a plurality of domain intervals including the domain interval indicated by the input, determining a cost indicator for each candidate technique as applied to the domain interval indicated by the input, and selecting a technique for the domain interval indicated by the input based on the cost indicators.

In another exemplary embodiment, a method may include solving a function with an input, wherein the function is solved via a selected technique associated with a domain interval indicated by the input. The selected technique may have been selected by identifying candidate techniques, separating a domain of the function into a plurality of domain intervals including the domain interval indicated by the input, determining a cost indicator for each candidate technique as applied to the domain interval indicated by the input, and selecting a technique for the domain interval indicated by the input based on the cost indicators.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of an apparatus for identifying techniques for solving functions according to various exemplary embodiments of the present invention;

FIG. 2 is a schematic block diagram of an apparatus configured to solve a function via a selected technique according to various exemplary embodiments of the present invention;

FIG. 3 is a flowchart of a method for identifying techniques for solving functions according to various exemplary embodiments of the present invention; and

FIG. 4 is a flowchart of a method of solving a function via a selected technique according to various exemplary embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, operated on, and/or stored in accordance with embodiments of the present invention. Moreover, the term “exemplary,” as used herein, is not provided to convey any qualitative assessment, but instead to merely convey an illustration of an example.

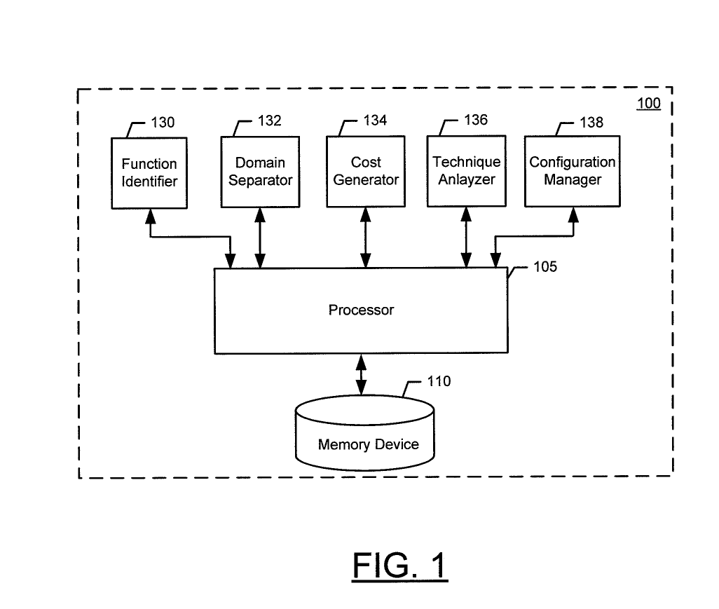

FIG. 1 illustrates an exemplary apparatus 100 that may provide for identifying techniques for solving functions. According to various exemplary embodiments of the present invention, the apparatus 100 may be embodied as, or included as a component of, a computing device such as any type of wired or wireless computing device including, for example, a computer, a server, a computer system or the like. Further, the apparatus 100 may be configured to implement various aspects of the present invention as described herein including, for example, various exemplary methods of the present invention, where the methods may be implemented by means of a hardware or software configured processor, computer-readable medium, or the like.

The apparatus 100 may include or otherwise be in communication with a processor 105, and a memory device 1 10. In some embodiments, the apparatus 100 may also include a communications interface for connectivity to a network, a user interface to interface with a user of the apparatus 100, and/or an output device that may be configured to allow data, such as application processor configuration data, to be copied onto a removable media, such as, a memory card, a compact disc, a digital versatile disc, a floppy disk, or the like. The processor 105 may be embodied as various means including, for example, a microprocessor, a coprocessor, a controller, or various other processing devices including integrated circuits such as, for example, an ASIC (application specific integrated circuit), an FPGA (field programmable gate array), or a hardware accelerator. In an exemplary embodiment, the processor 105 may be configured to execute instructions stored in the memory device 110 or instructions otherwise accessible to the processor 105. Processor 105 may also be configured to facilitate communications via the communications interface by, for example, controlling hardware and/or software included in the communications interface.

The memory device 110 may be a computer-readable storage medium that may include volatile and/or non-volatile memory. For example, memory device 110 may include Random Access Memory (RAM) including dynamic and/or static RAM, on-chip or off-chip cache memory, and/or the like. Further, memory device 110 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 110 may include a cache area for temporary storage of data. In this regard, some or all of memory device 110 may be included within the processor 105.

Further, the memory device 110 may be configured to store information, data, applications, computer-readable program code instructions, or the like for enabling the processor 105 and the apparatus 100 to carry out various functions in accordance with exemplary embodiments of the present invention. For example, the memory device 110 could be configured to buffer input data for processing by the processor 105. Additionally, or alternatively, the memory device 110 may be configured to store instructions for execution by the processor 105.

The function identifier 130, domain separator 132, cost generator 134, technique analyzer 136, and configuration manager 138 of apparatus 100 may be any means or device embodied in hardware, software, or a combination of hardware and software, such as processor 105 implementing software instructions or a hardware configured processor 105, that is configured to carry out the functions of function identifier 130, domain separator 132, cost generator 134, technique analyzer 136, and/or configuration manager 138 as described herein. In an exemplary embodiment, the processor 105 may include, or otherwise control function identifier 130, domain separator 132, cost generator 134, technique analyzer 136, and/or configuration manager 138. In various exemplary embodiments, function identifier 130, domain separator 132, cost generator 134, technique analyzer 136, and/or configuration manager 138 may reside on differing apparatuses such that some or all of the functionality of the function identifier 130, domain separator 132, cost generator 134, technique analyzer 136, and/or configuration manager 138 may be performed by a first apparatus, and the remainder of the functionality of the function identifier 130, domain separator 132, cost generator 134, technique analyzer 136, and/or configuration manager 138 may be performed by one or more other apparatuses.

The function identifier 130 may be configured to identify a function. The function may be a mathematical function, such as a linear function, an exponential function, a transcendental function, a trigonometric function, an algebraic function, a differential function, combinations thereof, or the like. The function may include any number of variables and may be calculated over a domain for each of the variables or a generalized domain for all variables. Examples of functions may be f(x)=sin x, f(x)=ax²+bx+c, or the like. In some embodiments, the function may be defined by an application that may apply the results of the function. For example, in a communications application, the identified function may be for an estimated frequency error for subframes of an orthogonal frequency division multiplexing (OFDM) communications system.

In some exemplary embodiments, identifying the function may include receiving the function via the communications interface from, for example, another network device, or via the user interface from a user. In some exemplary embodiments, identifying the function may include retrieving the function from a memory device, such as memory device 110. In some exemplary embodiments, the function may be identified from an application being executed by processor 105.

The function identifier 130 may also be configured to identify candidate techniques for solving the function. In this regard, the candidate techniques may be interpolation and/or approximation methods for solving a function. For example, the candidate techniques may include the CORDIC method, the Briggs' method for logarithms, the Newton's method, the Taylor series expansion, the Spline interpolation, the linear interpolation, the Padé rational approximation, the Chebychev approximation, or the like. Use of the candidate techniques to solve a function may result in using elementary operations (e.g., addition, multiplication, division, etc.) to determine or approximate the solution of the function on a processing device.

The function identifier 130 may also be configured to identify candidate techniques where the candidate techniques may be of a same technique type, but have different accuracy levels. Further, the accuracy levels may be associated with candidate techniques employing approximations using polynomials of different orders. In this regard, for example, a Taylor polynomial of differing orders may be considered separate candidate techniques. Moreover, the same technique type (e.g., Taylor polynomial) may be utilized as different candidate techniques, where each candidate technique in this regard is directed to a different level of accuracy.

In some exemplary embodiments, identifying the candidate techniques for solving the function may include receiving the candidate techniques via the communications interface from, for example, another network device, or via the user interface from a user. In some exemplary embodiments, identifying the candidate techniques may include retrieving the candidate techniques from a memory device, such as memory device 110. In some exemplary embodiments, the candidate techniques may be identified from an application being executed by processor 105.

Further, the function identifier 130 may be configured to receive a maximum error for solutions of the function. In this regard, the maximum error may define the accuracy of a result of a function for each candidate technique. In one exemplary embodiment where the variable values and output values of the function are 16-bit fixed point integer representations, an example maximum error may be 1/(2̂15). Candidate techniques may also have associated methods for determining or calculating the accuracy of the candidate techniques. In this regard, the maximum error may be calculated using the associated methods and the apparatus 100 may be configured to do so. The maximum error may be received via the communications interface from, for example, another network device, or via the user interface from a user.

The domain separator 132 may be configured to separate a domain of the function into a plurality of domain intervals. In this regard, the domain, which may also be referred to as a variable range, may be the range of values for a variable of the function. For example, a variable of the function may have a domain of negative infinity to positive infinity, zero to one, negative π to positive π, or the like. In exemplary embodiments where the function includes multiple variables, a domain may be identified for each variable for the function or a generalized domain may be identified.

Each domain may be separated into a plurality of domain intervals. In this regard, a domain may be separated into uniform sized domain intervals or non-uniformed sized domain intervals. For example, if a domain is zero to five, the domain intervals may be zero to one, one to two, two to three, three to four, and four to five. Further, in some exemplary embodiments, the domain of zero to five may be separated into domain intervals zero to one, two to four, and four to five. In one exemplary embodiment, the domain may be separated into domain intervals such that the extents of each domain interval are a power of two (e.g., two to four, four to eight, eight to sixteen, etc.).

The cost generator 134 may be configured to determine respective cost indicators for each candidate technique as applied to each domain interval of the function. In some exemplary embodiments, the memory device 110 may be configured to store the cost indicators for selection of the selected techniques. The cost indicators may be indicative of a computation cost of utilizing a particular candidate technique for a respective domain interval. In this regard, each candidate technique may be analyzed with respect to each domain interval to determine the cost indicators. Analyzing the candidate technique with respect to a domain interval may involve solving the function using a value for the variable that is within the domain interval. In some exemplary embodiments, analyzing the candidate techniques may involve solving the function twice, where the variables used to solve the function are near or at the extents of the domain interval.

The cost indicators may be determined based on a variety of criteria and conditions. In some exemplary embodiments, the cost indicators may be determined based on the number of elementary arithmetic operations (e.g., addition, multiplication, division, etc.) required to solve the function using a candidate technique. In some exemplary embodiments, the cost generator 134 may be configured to determine the respective cost indicators based on respective times or respective power consumption for solving the function using each candidate technique as applied to each domain interval of the function. In this regard, the cost generator may implement a timer to determine how long each candidate technique takes to determine a solution for the function. Additionally, or alternatively, the cost generator 134 may be configured to determine the respective cost indicators based on respective memory usage for solving the function using each candidate technique as applied to each domain interval of the function. In this regard, the number of memory location accesses may be counted while solving the function using the candidate techniques. Further, the maximum quantity of memory used to solve the function using the candidate techniques may be considered in the cost indicators.

Additionally, or alternatively, the cost generator 134 may be configured to determine the respective cost indicators based on a platform architecture including an application processor. In this regard, the platform architecture may be representative of a device, such as a mass produced device, that will be configured to implement selected techniques when the devices are deployed in the field or used by consumers. The platform architecture may include the computing architecture of the device or the layout of computing components within the device such as, for example, the layout of the processors, memory devices, and the like. For example, the platform architecture may be that of a cellular phone, or another mobile terminal. In some exemplary embodiments, the platform architecture of a device may be emulated and cost indicator criteria may be determined based on solving the functions using the candidate techniques on the emulated platform. In some exemplary embodiments, the candidate techniques may be mapped to the platform to generate the platform architecture. The cost indicators may then be determined based on the operation of the platform architecture. In this manner, the cost indicators may determined in consideration of the efficiency of the overall platform architecture.

The technique analyzer 136 may be configured to select a technique for each domain interval based on the cost indicators. In this regard, each domain interval may have a cost indicator for each candidate technique. The cost indicators may be analyzed on a domain interval-by-domain interval basis to select candidate techniques for each domain interval. In some exemplary embodiments, a candidate technique may be selected for a domain interval because the technique is associated with a cost indicator having the minimum cost for the respective domain interval. The cost indicators may also be configured based on the criteria to describe, for example, the selections that result in a minimum amount of arithmetic calculations with larger memory usage, minimum memory usage with a larger number of arithmetic calculations, or the like.

In some exemplary embodiments, the selection of candidate techniques may be based on the maximum error or a maximum error threshold. Candidate techniques that provide results outside of the maximum error threshold may be eliminated from selection. Further, candidate techniques that are of the same type but having different accuracy levels may provide for solutions that are within the maximum error and have a minimum cost indicator value. Also, in some exemplary embodiments, selection of the selected techniques may be facilitated by user input via, for example, the user interface to assist in selecting a mix of techniques.

The selected techniques may comprise a mixture of techniques for solving the function over the entire domain. When applied, inputs to the function may determine the domain interval and the associated selected technique for the domain interval. The selected technique for that domain interval may then be used to solve the function.

The configuration manager 138 may be configured to provide for configuring an application processor to solve the function via the selected technique and the respective domain intervals. In this regard, the configuration manager 138 may facilitate configuring an application processor on a device, or a plurality of application processors on plurality of devices, to enable the devices to solve the function using the selected techniques when a solution to the function is needed. In some exemplary embodiments, the configuration manager 138 may configure the processors by being an input to a manufacturing process for the application processors that are hardware or software configured. In exemplary embodiments where the application processors are software configured, the configuration manager may facilitate configuring a memory device associated with the application processors to thereby configure the application processors.

To communicate the selected techniques to the application processors, the configuration manager may output the selected techniques via the communications interface or via the output device or a removable memory device. In some exemplary embodiments, the communications interface of apparatus 100 may use a wired or wireless communications link to update software in a memory device associated with the application processors.

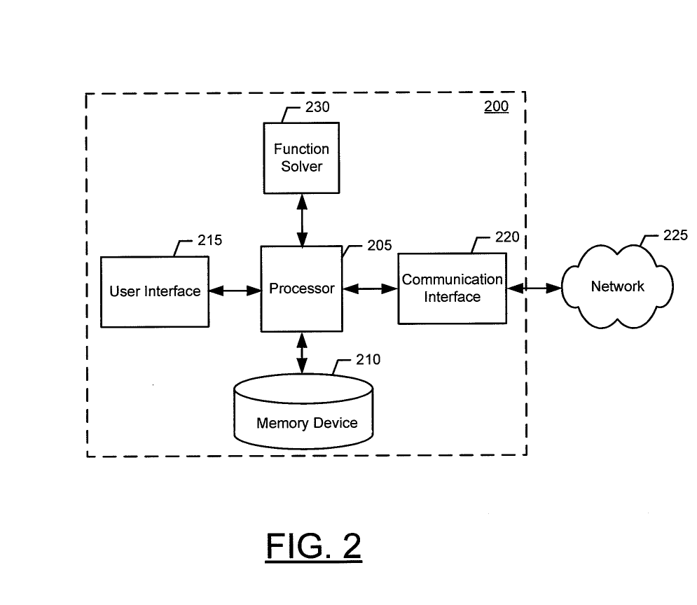

FIG. 2 illustrates a schematic block diagram of an apparatus 200 configured to solve a function via selected techniques according to various exemplary embodiments of the present invention. In some exemplary embodiments, the apparatus 200 may be embodied as, or included as a component of, a computing device which may or may not have wired or wireless communications capabilities. Some examples of the apparatus 200 may include a computer, a server, a calculator, a mobile terminal such as, a mobile telephone, a portable digital assistant (PDA), a pager, a mobile television, a gaming device, a mobile computer, a laptop computer, a camera, a video recorder, an audio/video player, a radio, and/or a global positioning system (GPS) device, a network entity such as an access point such as a base station, or any combination of the aforementioned, or the like. Further, the apparatus 200 may be configured to implement various aspects of the present invention as described herein including, for example, various exemplary methods of the present invention, where the methods may be implemented by means of a hardware or software configured processor, computer-readable medium, or the like.

The apparatus 200 may include or otherwise be in communication with a processor 205, a memory device 210, a user interface 215, and a communication interface 220. In some embodiments, the apparatus 200 need not include the user interface 215 and/or the communication interface 220. The processor 205 may be embodied as various means including, for example, a microprocessor, a coprocessor, a controller, or various other processing devices including integrated circuits such as, for example, an ASIC (application specific integrated circuit), an FPGA (field programmable gate array), or a hardware accelerator. In an exemplary embodiment, the processor 205 may be configured to execute instructions stored in the memory device 210 or instructions otherwise accessible to the processor 205. Processor 205 may also be configured to facilitate communications via the communications interface 220 by, for example, controlling hardware and/or software included in the communications interface 220.

The memory device 210 may be a computer-readable storage medium that may include volatile and/or non-volatile memory. For example, memory device 210 may include Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, or the like for enabling the processor 205 and the apparatus 200 to carry out various functions in accordance with exemplary embodiments of the present invention. For example, the memory device 210 could be configured to buffer input data for processing by the processor 205. Additionally, or alternatively, the memory device 210 may be configured to store instructions for execution by the processor 205.

The communication interface 220 may be any device or means embodied in either hardware, software, or a combination of hardware and software that is configured to receive and/or transmit data from/to a network and/or any other device or module in communication with the apparatus 200. In this regard, the communication interface 220 may include, for example, an antenna, a transmitter, a receiver, a transceiver and/or supporting hardware, including a processor or software for enabling communications with network 225. Via the communication interface 220 and the network 225, the apparatus 200 may communicate with various other network entities.

The communications interface 220 may be configured to provide for communications in accordance with any wired or wireless communication standard. For example, communications interface 220 may be configured to provide for communications in accordance with second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 220 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like.

The function solver 230 of apparatus 200 may be any means or device embodied in hardware, software, or a combination of hardware and software, such as processor 205 implementing software instructions or a hardware configured processor 205, that is configured to carry out the functions of the function solver 230 as described herein. In an exemplary embodiment, the processor 205 may include, or otherwise control the function solver 230. In various exemplary embodiments, the function solver 230 may reside on differing apparatuses such that some or all of the functionality of the function solver 230 may be performed by a first apparatus, and the remainder of the functionality of the function solver 230 may be performed by one or more other apparatuses.

The function solver 203 may be configured to solve a function with the selected techniques that have been selected as described above, and the function solver 230 may be an exemplary embodiment of an application processor. In this regard, the function solver may be configured to solve a function with an input. The input may be one or more values for the variables of the function. The input may be provided via the user interface 215, the communication interface 220, or some other entity that may be controlled by, or otherwise interact with the processor 205.

The function solver 230 may be configured to solve the function via the selected techniques associated with a domain interval indicated by the input. In this regard, the input may be one or more values for the one or more variables of the function within a domain interval, and through the input values the domain interval may be identified. Accordingly, the selected technique may be identified based on the domain interval. The function may then be solved using the variable values and the selected technique.

In various embodiments, the selected technique may have been received by the apparatus 200 via the apparatus 100 as described above. In some exemplary embodiments, the selected technique may be determined by identifying candidate techniques and separating a domain of the function into a plurality of domain intervals including the domain interval indicated by the input. Further, the selected technique may be determined by determining a cost indicator for each candidate technique as applied to the domain interval indicated by the input, and selecting a technique for the domain interval indicated by the input based on the cost indicators.

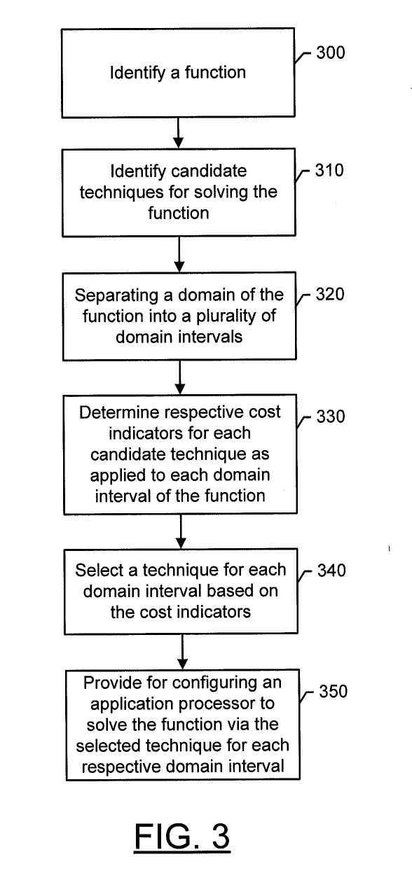

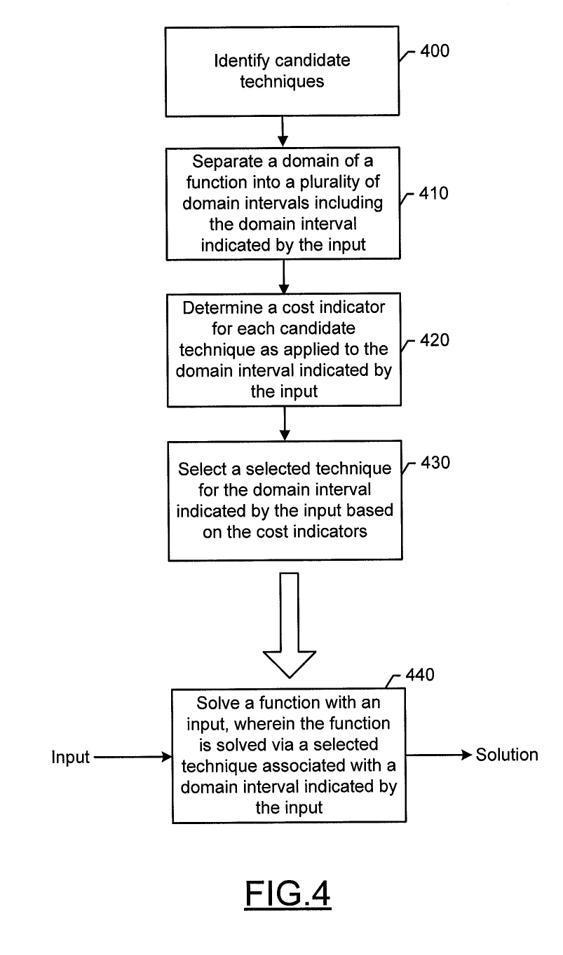

FIGS. 3 and 4 illustrate flowcharts of a system, method, and computer program product according to exemplary embodiments of the invention. It will be understood that each block, step, or operation of the flowcharts, and/or combinations of blocks, steps, or operations in the flowcharts, can be implemented by various means. Means for implementing the blocks, steps, or operations of the flowchart, and/or combinations of the blocks, steps or operations in the flowcharts may include hardware, firmware, and/or software including one or more computer program code instructions, program instructions, or executable computer-readable program code instructions. In one exemplary embodiment, one or more of the procedures described herein may be embodied by program code instructions. In this regard, the program code instructions which embody the procedures described herein may be stored by or on a memory device, such as memory device 110 or 210, of an apparatus, such as apparatus 100 or 200, and executed by a processor, such as the processor 105 or 205. As will be appreciated, any such program code instructions may be loaded onto a computer or other programmable apparatus (e.g., processor 105 or 205, memory device 110 or 210) to produce a machine, such that the instructions which execute on the computer or other programmable apparatus create means for implementing the functions specified in the flowcharts' block(s), step(s), or operation(s). These program code instructions may also be stored in a computer-readable storage medium that can direct a computer, a processor, or other programmable apparatus to function in a particular manner, such that the instructions stored in the computer-readable storage medium produce an article of manufacture including instruction means which implement the function specified in the flowchart's block(s), step(s), or operation(s). The program code instructions may also be loaded onto a computer, processor, or other programmable apparatus to cause a series of operational steps to be performed on or by the computer, processor, or other programmable apparatus to produce a computer-implemented process such that the instructions which execute on the computer, processor, or other programmable apparatus provide steps for implementing the functions specified in the flowcharts' block(s), step(s), or operation(s).

Accordingly, blocks, steps, or operations of the flowcharts support combinations of means for performing the specified functions, combinations of steps for performing the specified functions, and program code instruction means for performing the specified functions. It will also be understood that one or more blocks, steps, or operations of the flowcharts, and combinations of blocks, steps, or operations in the flowcharts, can be implemented by special purpose hardware-based computer systems which perform the specified functions or steps, or combinations of special purpose hardware and program code instructions.

FIG. 3 depicts a flowchart describing an exemplary method of the present invention. The exemplary method may include identifying a function at 300 and identifying candidate techniques for solving the function at 310. The candidate techniques may include techniques of the same type, but differing in that the candidate techniques have different accuracy levels. In this regard, in some exemplary embodiments, the accuracy levels may be associated with candidate techniques employing approximations using polynomials of different orders. At 320, the exemplary method may include separating a domain of the function into a plurality of domain intervals.

At 330, the exemplary method may include determining respective cost indicators for each candidate technique as applied to each domain interval of the function. According to various exemplary embodiments, the cost indicators may be determined using each candidate technique as applied to each domain interval of the function based on the number of computations needed to solve the function, respective times for solving the function, or respective memory usage for solving the function. In some exemplary embodiments, the cost indicators may be determined based on a platform architecture that includes an application processor.

At 340, a selected technique for each domain interval may be selected based on the cost indicators. In some exemplary embodiments, selecting the selected technique may be based on the maximum error threshold. Additionally, at 350, the exemplary method may include providing for configuring an application processor to solve the function via the selected techniques for the respective domain intervals.

The following provides example implementations of an exemplary embodiment of the method of FIG. 3 for the trigonometric function sinum, hereinafter referred to as sin(x). In this implementation, sin(x) is defined with a domain of negative π to positive π, since sin(x) is a periodic function with a period 2π. The domain may be further restricted to the interval of zero to π/2 since the results for values outside such a range may be easily reproducible. Restrictions of this sort can allow for simpler solutions while also having improved accuracy.

The values for the variable x over the domain of zero to π/2 may be encoded to be 16-bit fixed point values. A candidate technique, namely an approximation using the Taylor polynomials, may be identified and cost indicators may be determined. In this example, a desired maximum error resulting in a determination that the polynomial used to approximate sin(x) should be of grade 9. In this regard, the Horner's rule to polynomials may be applied to acquire an equivalent and simplified polynomials. Based on the foregoing, the cost indicators may be calculated for this candidate technique.

With respect to an additional candidate technique, a different actuary level of the Taylor polynomial may be used. In this regard, based on the domain interval, it may be determined that valid approximations within the maximum error may be identified with candidate techniques having polynomials of grade 3, 5, 7, and 9. The cost indicators for these candidate techniques may be calculated by approximating the function for a given value of the x variable for each candidate technique. The resultant cost indicators may be considered, and based on the cost indicators, a candidate technique may be selected for the domain interval, for example, as the least costly technique. The selected technique may then be used to configure an application processor for use by the application processor when a solution to the same function is needed.

In accordance with this example, another candidate technique that may be considered may be based on the Spline interpolation. The domain of the function may be separated into sixteen intervals and are stored in a look-up table with the corresponding value for sin(x). Calculating the Spline interpolation may then provide a table of coefficients which represent fifteen of the different polynomials having grade 3. Calculation of the maximum error for each domain interval may show an acceptable error across the domain. Again, the Horner's rule may be applied to the polynomials and then the cost indicators may be determined for each of the sixteen domain intervals. Based on the cost indicators, the most appropriate polynomial may be selected for each of the domain intervals.

FIG. 4 depicts a flowchart describing an exemplary method of solving a function via a selected technique in accordance with an embodiment of the present invention. The exemplary method may include solving a function with an input at 440. In this regard, the function may be solved via a selected technique associated with a domain interval indicated by the input.

The selected technique for solving the function of 440 may have been selected by identifying candidate techniques at 400, and separating a domain of a function into a plurality of domain intervals including the domain interval indicated by the input at 410. Further, the selection of the selected technique for solving the function of 440 may also include determining a cost indicator for each candidate technique as applied to the domain interval indicated by the input at 420 and selecting a technique for the domain interval indicated by the input based on the cost indicators at 430.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
identifying a function;
identifying candidate techniques for solving the function;
separating a domain of the function into a plurality of domain intervals;
determining respective cost indicators for each candidate technique as applied to each domain interval of the function;
selecting a technique for each domain interval based on the cost indicators; and
providing for configuring an application processor to solve the function via the selected technique for each respective domain interval.

2. The method of claim 1, wherein selecting the technique for each domain interval includes selecting the technique for each domain interval based on a maximum error threshold.

3. The method of claim 1, wherein determining the respective cost indicators includes determining the respective cost indicators based on respective numbers of arithmetic computations needed for solving the function using each candidate technique as applied to each domain interval of the function.

4. The method of claim 1, wherein determining the respective cost indicators includes determining the respective cost indicators based on respective memory usage required to solve the function using each candidate technique as applied to each domain interval of the function.

5. The method of claim 1, wherein determining the respective cost indicators includes determining the respective cost indicators based on a platform architecture including the application processor.

6. The method of claim 1, wherein identifying the candidate techniques includes identifying the candidate techniques, the candidate techniques being of a same technique type but having different accuracy levels.

7. The method of claim 5, wherein identifying the candidate techniques includes identifying the candidate techniques, the candidate techniques being of the same technique type but having different accuracy levels, the accuracy levels being associated with candidate techniques employing approximations using polynomials of different orders.

8. An apparatus comprising a processor, the processor configured to:
identify a function;
identify candidate techniques for solving the function;
separate a domain of the function into a plurality of domain intervals;
determine respective cost indicators for each candidate technique as applied to each domain interval of the function;
select a technique for each domain interval based on the cost indicators; and
provide for configuring an application processor to solve the function via the selected technique for each respective domain interval.

9. The apparatus of claim 8, wherein the processor configured to select the technique for each domain interval includes being configured to select the technique for each domain interval based on a maximum error threshold.

10. The apparatus of claim 8, wherein the processor configured to determine the respective cost indicators includes being configured to determine the respective cost indicators based on respective numbers of arithmetic computations needed for solving the function using each candidate technique as applied to each domain interval of the function.

11. The apparatus of claim 8, wherein the processor configured to determine the respective cost indicators includes being configured to determine the respective cost indicators based on respective memory usage for solving the function using each candidate technique as applied to each domain interval of the function.

12. The apparatus of claim 8, wherein the processor configured to determine the respective cost indicators includes being configured to determine the respective cost indicators based on a platform architecture including the application processor.

13. The apparatus of claim 8, wherein the processor configured to identify the candidate techniques includes being configured to identify the candidate techniques, the candidate techniques being of a same technique type but having different accuracy levels.

14. The apparatus of claim 13, wherein the processor configured to identify the candidate techniques includes being configured to identify the candidate techniques, the candidate techniques being of the same technique type but having different accuracy levels, the accuracy levels being associated with candidate techniques employing approximations using polynomials of different orders.

15. The apparatus of claim 8 further comprising a memory device, the memory device configured to store the cost indicators for selection of the selected technique.

16. A computer program product comprising at least one computer-readable storage medium having executable computer-readable program code instructions stored therein, the computer-readable program code instructions configured to:
identify a function;
identify candidate techniques for solving the function;
separate a domain of the function into a plurality of domain intervals;
determine respective cost indicators for each candidate technique as applied to each domain interval of the function;
select a technique for each domain interval based on the cost indicators; and
provide for configuring an application processor to solve the function via the selected technique for each respective domain interval.

17. The computer program product of claim 16, wherein the computer-readable program code instructions configured to select the technique for each domain interval includes being configured to select the technique for each domain interval based on a maximum error threshold.

18. The computer program product of claim 16, wherein the computer-readable program code instructions configured to determine the respective cost indicators include being configured to determine the respective cost indicators based on respective numbers of arithmetic computations needed for solving the function using each candidate technique as applied to each domain interval of the function.

19. The computer program product of claim 16, wherein the computer-readable program code instructions configured to determine the respective cost indicators includes being configured to determine the respective cost indicators based on respective memory usage for solving the function using each candidate technique as applied to each domain interval of the function.

20. The computer program product of claim 16, wherein the computer-readable program code instructions configured to determine the respective cost indicators includes being configured to determine the respective cost indicators based on a platform architecture including the application processor.

21. The computer program product of claim 16, wherein the computer-readable program code instructions configured to identify the candidate techniques includes being configured to identify the candidate techniques, the candidate techniques being of a same technique type but having different accuracy levels.

22. The computer program product of claim 20, wherein the computer-readable program code instructions configured to identify the candidate techniques includes being configured to identify the candidate techniques, the candidate techniques being of the same technique type but having different accuracy levels, the accuracy levels being associated with candidate techniques employing approximations using polynomials of different orders.

23. An apparatus comprising:
means for identifying a function;
means for identifying candidate techniques for solving the function;
means for separating a domain of the function into a plurality of domain intervals;
means for determining respective cost indicators for each candidate technique as applied to each domain interval of the function;
means for selecting a technique for each domain interval based on the cost indicators; and
means for providing for configuring an application processor to solve the function via the selected technique for each respective domain interval.

24. The apparatus of claim 23, wherein means for determining the respective cost indicators includes means for determining the respective cost indicators based on a platform architecture including the application processor.

25. A method comprising:
solving a function with an input, wherein the function is solved via a selected technique associated with a domain interval indicated by the input, the selected technique having been selected by:
identifying candidate techniques;
separating a domain of the function into a plurality of domain intervals including the domain interval indicated by the input;
determining a cost indicator for each candidate technique as applied to the domain interval indicated by the input; and
selecting the technique for the domain interval indicated by the input based on the cost indicators.

26. An apparatus comprising a processor, the processor configured to:
solve a function with an input, wherein the function is solved via a selected technique associated with a domain interval indicated by the input, the selected technique having been selected by:
identifying candidate techniques;
separating a domain of the function into a plurality of domain intervals including the domain interval indicated by the input;
determining a cost indicator for each candidate technique as applied to the domain interval indicated by the input; and
selecting the technique for the domain interval indicated by the input based on the cost indicators.
